(19) United States
(12) Patent Application Publication
(10) Pub. No.: US 2026/0136256 A1
(43) Pub. Date: May 14, 2026

(54) ENABLING ROAMING IN A HIERARCHICAL ARCHITECTURE HAVING A DISTRIBUTED SEAMLESS MOBILITY DOMAIN (SMD) OF A CENTRALIZED SMD

(71) Applicant: Cisco Technology, Inc., San Jose, CA (US)

(72) Inventors: Brian D. Hart, Sunnyvale, CA (US); Binita Gupta, San Diego, CA (US)

(73) Assignee: Cisco Technology, Inc., San Jose, CA (US)

(21) Appl. No.: 19/281,368

(22) Filed: Jul. 25, 2025

Related U.S. Application Data
(60) Provisional application No. 63/718,358, filed on Nov. 8, 2024.

(51) Int. Cl. H04W 36/18; H04W 60/04; H04W 60/06; H04W 84/12

(52) U.S. Cl. CPC H04W 36/18; H04W 60/04; H04W 60/06; H04W 84/12

(57) ABSTRACT

Enabling roaming in a hierarchical architecture having a distributed Seamless Mobility Domain (SMD) of a centralized SMD may be provided. A request to roam to a second AP MLD may be received from a first station associated with a first AP MLD of a hierarchical architecture. The hierarchical architecture may include a distributed SMD including a first centralized SMD. The first centralized SMD may include the first AP MLD. It may be determined that the second AP MLD belongs to the first centralized SMD. In response to determining that the second AP MLD belongs to the first centralized SMD, data exchanges for the first station may be transitioned from links of the first AP MLD to through links of the second AP MLD with the first station remaining associated with the first centralized SMD.

### RELATED APPLICATION

Under provisions of 35 U.S.C. § 119(e), Applicant claims the benefit of U.S. Provisional Application No. 63/718,358, filed Nov. 8, 2024, which is incorporated herein by reference.

### TECHNICAL FIELD

The present disclosure relates generally to enabling roaming in a hierarchical architecture having a distributed Seamless Mobility Domain (SMD) of a centralized SMD.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for enabling roaming in a hierarchical architecture having a distributed Seamless Mobility Domain (SMD) of a centralized SMD;

FIG. 2 is a flow chart of a first method for enabling roaming in a hierarchical architecture having a distributed Seamless Mobility Domain (SMD) of a centralized SMD;

FIG. 3 is a flow chart of a second method for enabling roaming in a hierarchical architecture having a distributed SMD of a centralized SMD;

FIG. 4 is a flow chart of a third method for enabling roaming in a hierarchical architecture having a distributed SMD of a centralized SMD; ;

FIG. 5 is a flow chart of a second method for providing associating with a hierarchical architecture; and

FIG. 6 is a block diagram of a computing device.

### DETAILED DESCRIPTION

### Overview

Enabling roaming in a hierarchical architecture having a distributed Seamless Mobility Domain (SMD) with a centralized SMD may be provided. A request to roam to a second AP MLD may be received from a first station associated with a first AP MLD of a hierarchical architecture. The hierarchical architecture may include a distributed SMD including a first centralized SMD. The first centralized SMD may include the first AP MLD. It may be determined that the second AP MLD belongs to the first centralized SMD. In response to determining that the second AP MLD belongs to the first centralized SMD, data exchanges for the first station may be transitioned from links of the first AP MLD to through links of the second AP MLD with the first station remaining associated with the first centralized SMD.

Both the foregoing overview and the following example implementations are examples and explanatory only and should not be considered to restrict the disclosure's scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Seamless roaming capability has been an area of interest for improving roaming quality within wireless networks. For instance, the next generation of the Institute of Electrical and Electronics Engineers (IEEE) 802.11 (that is, Wi-Fi 8) may seek roaming enhancements to support more reliable and seamless roaming. To achieve seamless roaming, a roaming transition time and delays added due to roaming related operations may need to be reduced. In one example, to support seamless roaming, a Station (STA) may create an association with a Seamless Mobility Domain (SMD) instead of with an individual Access Point (AP) Multi-Link Devices (MLDs). Associating with a SMD may enable the STA to roam seamlessly between member AP MLDs of the SMD without requiring reassociation and reestablishment of contexts with each new AP MLD. That is, associating with a SMD may ensure that when the STA moves from the current AP MLD to a target AP MLD, the STA may not need to perform reassociation and rekeying, and the STA context may be transferred from the current AP MLD to the target AP MLD to achieve seamless roaming. Thus, by enabling the STA to associate with a SMD that includes multiple member AP MLDs may significantly reduce roaming time to realize seamless roaming (e.g., smooth and continuous roaming with no apparent interruption in data communication) and significantly improve a STA's wireless performance in terms of increased throughput, reduced latency, and higher range, as illustrative, non-limiting examples.

A distributed SMD may include multiple member AP MLDs each with a Media Access Control (MAC)-Service Access Point (SAP) to a Distribution System (DS). In a distributed SMD, association may typically be to the distributed SMD with a single Pairwise Transient Key (PTK) for the STA, and with a STA state (for example, Sequence Numbers (SN), Packet number (PN), etc.) being transferred from an old AP MLD to a target AP MLD as part of the roaming. A distributed SMD may have a dual Downlink (DL) immediately after the roam (thru old and target AP MLDs) but may include a one-at-time Uplink (UL) (for example, through old AP MLD then thru target AP MLD). A distributed SMD may be a logical entity and may reside on one of the member AP MLDs or a central controller (for example, Wireless Local Area Network (LAN) Controller (WLC). In some examples, the distributed SMD may be distributed across multiple member AP MLDs.

Enhanced Fast Basic Service Set (BSS) Transition (FT) (EFT) roaming, which may be a variation of SMD in the sense that there are multiple MAC-SAPs across the SMD, one for each AP MLD, the PTK may not be shared. In addition, moving from one AP MLD to another may or may not involve a reassociation. Some client contexts may be transferred between AP MLDs, but it may be reduced. For example, PN may not be transferred, but may still be enough to avoid UL duplication or out-of-order delivery. The dual DL may still available be available in EFT roaming.

A centralized SMD may include disaggregated or non-co-located AP MLDs with a Centralized Box (CB) providing a single MAC-SAP to the DS across multiple member AP MLDs. A centralized SMD may include an upper portion of Upper-MAC (U-MAC) and a lower portion of U-MAC of member AP MLDs. A lower-MAC (L-MAC) may be located on multiple non-co-located CBs (NCBs) each containing the lower portion of the U-MAC, the L-MAC, a baseband, and a Radio Frequency (RF) for a small number of links. Hence, a centralized SMD may have multiple links. Each NCB may represent an affiliated AP MLD of the centralized SMD. In some examples, in an enhanced centralized SMD, a non-AP MLD may form links with multiple member AP MLDs.

Both distributed SMD and EFT may have a high scalability (that is, limited excess network traffic and sporadic times needing low latency) but imperfect roaming. For example, an uplink pause may be needed while the infrastructure moves context from the old AP MLD to the target AP MLD. A centralized SMD, on the other hand, may have a low scalability as it may require a super-fast high-bandwidth connectivity between the CB and an NCB, to carry the latest Block Acknowledgement (BA) state and to carry frames to and from each NCB with very low delay with potential duplication. However, a centralized SMD may offer a better roaming within the centralized SMD since data may be sent through any NCB and reordering and replay protection may occur in one place at the CB with no delays related to context transfer. The centralized SMD may therefore be suited for a home and the distributed SMD may be suited for an enterprise.

The disclosure provides a hierarchical roaming architecture. The hierarchical roaming architecture may include a distributed SMD that covers one or more centralized SMDs and zero or more AP MLDs. The centralized SMD may be hosted on a CB that may provide a MAC-SAP to the DS across multiple affiliated AP MLDs of that centralized SMD hosted on multiple NCBs. A centralized SMD may have multiple affiliated AP MLDs or multiple affiliated APs or links that may be hosted at different NCBs. Each AP MLDs may be an IEEE 802.11be defined AP MLD or a UHR AP MLD. The hierarchical architecture may enable seamless roaming from: a) one centralized SMD to another centralized SMD in the distributed SMD, b) from a centralized SMD to another AP MLD in the centralized SMD, and c) from one AP MLD to another AP MLD in the distributed SMD.

For seamless roaming in the hierarchical roaming architecture, following procedure may apply. For a STA moving from a range of a first NCB to a range of a second NCB of the same centralized SMD, the STA may remain associated to that same centralized SMD. The STA may use centralized SMD mechanisms and smoothly transitions from exchanging data through links of the first NCB to exchanging data through the links of the second NCB. The AP MLD reconfiguration, add, or delete links protocol may be used to add and delete links as the STA moves between two NCBs of the same centralized SMD. In some examples, all links across multiple NCBs may established at association.

For a STA moving from a range of the NCBs of a first centralized SMD to a range of a NCB of a different (that is, a second) centralized SMD in the same distributed SMD, the STA may remain connected with the same distributed SMD. The STA may use the distributed SMD mechanisms and transition from exchanging data through the links of the NCBs of the first centralized SMD to exchanging data through the links of the NCBs of the second centralized SMD. The SMD mechanisms may involve a roaming preparation phase and then a roaming execution phase, with an uplink pause and a dual downlink phase. Thus, a roaming from a centralized SMD to another centralized SMD may be slower than roaming within a centralized SMD.

For a STA moving from a range of first NCBs of a first centralized SMD in a first distributed SMD to a range of second NCBs of a second centralized SMD in a different (that is, a second) distributed SMD of a FT Mobility Domain (FTMD), the STA may remain part of the same FTMD. The STA may use the FTMD mechanisms and transition from exchanging data through links of the first NCBs of the first centralized SMD of the first distributed SMD to exchanging data through links of the second NCBs of the second centralized SMD of the second distributed SMD. The FTMD mechanisms may involve FT request and response frames. Thus, a roaming from a distributed SMD to another distributed SMD may be slower than roaming from one centralized SMD to another centralized SMD and within a centralized SMD.

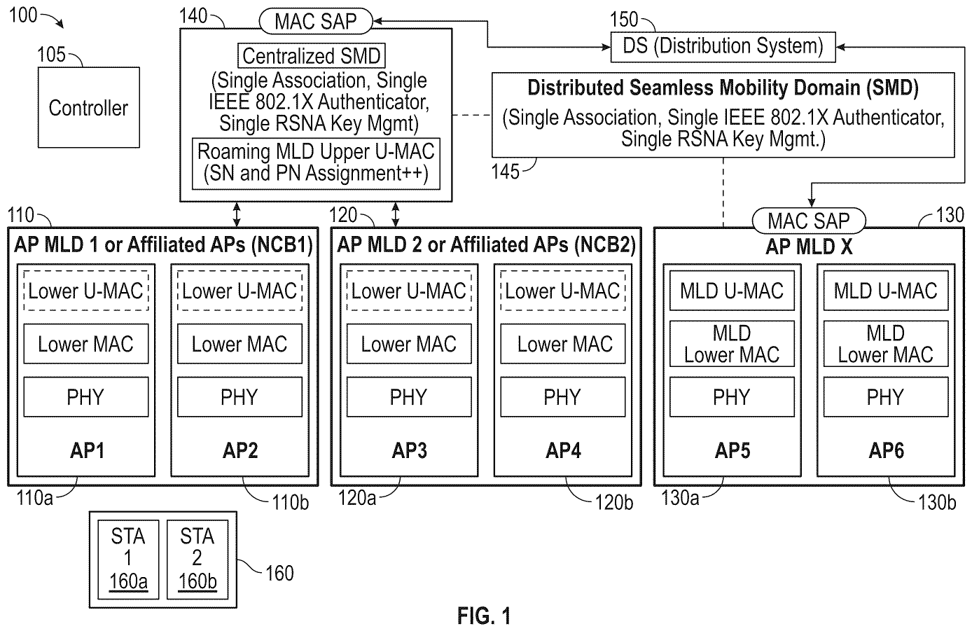

FIG. 1 is a block diagram of an operating environment 100 for enabling roaming in a hierarchical architecture having a distributed SMD of a centralized SMD. As shown in FIG. 1, operating environment 100 may comprise a controller 105, a plurality of AP MLDs, for example, a first AP MLD 110, a second AP MLD 120, and a third AP MLD 130. Each of the plurality of AP MLDs may include one or more APs. For example, first AP MLD 110 may include a first AP 110a and a second AP 110b, second AP MLD 120 may include a third AP 120a and a fourth AP 120b, and third AP MLD 130 may include a fifth AP 130a and a sixth AP 130b.

Operating environment 100 may further include a centralized SMD 140, a distributed SMD 145, a DS 150, and a non-AP MLD 160. Non-AP MLD 160 may include a first STA 160a and a second STA 160b. Centralized SMD 140 may include disaggregated or non-co-located member AP MLDs (that is, first AP MLD 110 and second AP-MLD 120) with a CB providing a single MAC-SAP to DS 150 across first AP MLD 110 and second AP-MLD 120. Centralized SMD 140 may include an upper portion of U-MAC and a lower portion of U-MAC of each member AP MLD. A lower-MAC (L-MAC) may be located on a first NCB of first AP MLD 110 (that is, NCB1) and a second NCB of second AP MLD 120. Each of NCB1 and NCB2 may contain the lower portion of the U-MAC, the L-MAC, a baseband, and a Radio Frequency (RF) for a small number of links. Although, centralized SMD 140 is shown to include only two member AP MLDs, it may contain more than two member AP MLDs. In addition, each member AP MLD of centralized SMD 140 may also be a member of another centralized SMD.

Distributed SMD 145 may include centralized SMD 140 and third AP MLD 130 each with a MAC-SAP to DS 150. Distributed SMD 145 may enable any STA of non-AP MLD 160 to roam seamlessly between member centralized SMD 140 and third AP MLD 130 without requiring reassociation and reestablishment of contexts with each new AP. Although centralized SMD 145 is shown to include only one member centralized SMD and one member AP MLD, it may include more than one member centralized SMDs. DS 150 may include wired ethernet or a mesh network used to connect multiple AP MLDs of operating environment 140.

In some examples, operating environment 100 may include more than one distributed SMDs. Such two or more distributed SMDs may be part of a FTMD. That is, in some example, operating environment 100 may include a FTMD as defined in IEEE 802.11r, where each MD may include one or more distributed SMDs. The FTMD may be identified by an FTMD Identifier (FTMD ID).

Distributed SMD 145 may provide a coverage environment, for example, but is not limited to, a Wireless LAN (WLAN) that may provide wireless network access (e.g., access to the WLAN for non-AP MLD 160 as it moves within the coverage environment). First STA 160a and second STA 160b each may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device.

Each of the plurality of APs may be compatible with specification standards such as, but not limited to, the IEEE 802.11 specification standard for example. The plurality of APs and STAs of operating environment 100 may use Multi-Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band.

Controller 105 may comprise a WLC and may provision and control the coverage environment (for example, a WLAN). In some implementations of the disclosure, controller 105 may be implemented by a Digital Network Architecture Center (DNAC) controller (i.e., a Software-Defined Network (SDN) controller.

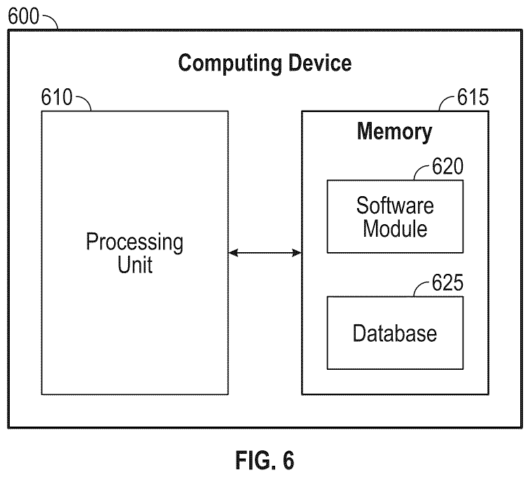

The elements described above of operating environment 100 (e.g., controller 105, first AP MLD 110, second AP MLD 120, third AP MLD 130, centralized SMD 140, distributed SMD 145, DS 150, and non-AP MLD 160) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 6, the elements of operating environment 100 may be practiced in a computing device 600.

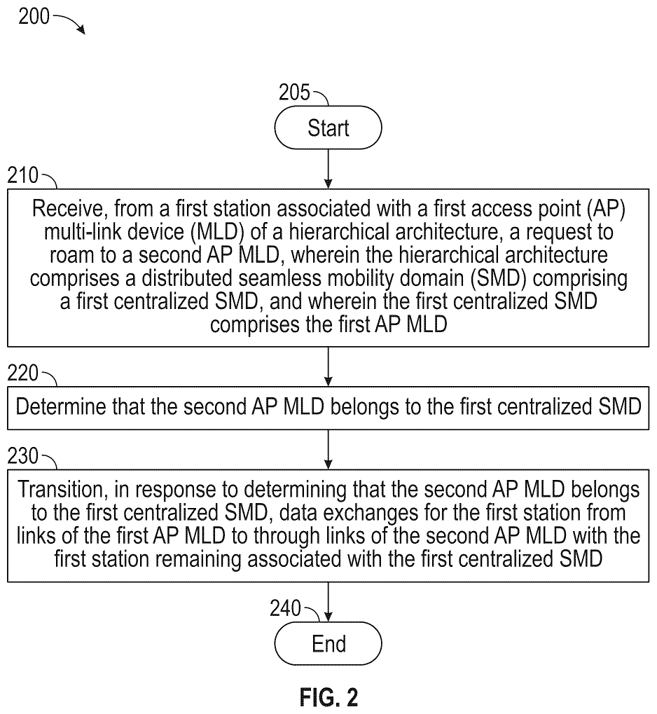

FIG. 2 is a flow chart setting forth the general stages involved in a first method 200 consistent with implementations of the disclosure for enabling roaming in a hierarchical architecture having distributed SMD 145 of centralized SMD 140. First method 200 may be implemented using first AP MLD 120 or centralized SMD 140 as described in more detail above with respect to FIG. 1. In some examples, first method 200 may be implemented using any of the plurality of AP MLDs as described in more detail above with respect to FIG. 1. Ways to implement the stages of method 200 will be described in greater detail below.

Method 200 may begin at starting block 205 and proceed to stage 210 where first AP MLD 110 may receive a request to roam to second AP MLD 120 from first STA 160a associated with first AP MLD 110 of a hierarchical architecture. As discussed above, the hierarchical architecture may comprise distributed SMD 145 that may include a first centralized SMD (for example, centralized SMD 140). The first centralized SMD (that is, centralized SMD 140) may comprise first AP MLD 110. In some examples, request to roam may be received at second AP MLD 120 if first STA 160a may already have moved in a range of second AP MLD 120. In some example, first STA 160a of non-AP MLD 160 may be associated with first AP 110a of first AP MLD 110 (that is, NCB1) or with both first AP 110a and second AP 110b of first AP MLD 110 (that is, NCB1). First STA 160a may roam or may intend to roam from a range of first AP MLD 110 (that is, NCB1) to a range of one of member APs of second AP MLD 120 (that is, NCB2). First STA 160a may send the request to roam to first AP MLD 110 indicating the intended roam.

After receiving the request to roam to second AP MLD 120 from first STA 160a at stage 210, method 200 may proceed to stage 220 where it may be determined that second AP MLD 120 belongs to the first centralized SMD (that is, centralized SMD 140). In some examples, the determination of whether second AP MLD 120 belongs to the first centralized SMD (that is, centralized SMD 140) may be made by first AP MLD 110 or centralized SMD 140. For example, first AP MLD 110 may forward the request to roam to centralized SMD 140, and centralized SMD 140 may determine whether second AP MLD 120 belongs to centralized SMD 140. Centralized SMD 140 may have information about its member AP MLDs.

Once having determined that second AP MLD 120 belongs to the first centralized SMD (that is, centralized SMD 140) at stage 220, method 200 may proceed to stage 230 where, in response to determining that second AP MLD 120 belongs to the first centralized SMD (that is, centralized SMD 140), data exchanges for first STA 160a may transition from links of first AP MLD 110 to through links of second AP MLD 120 with first STA 160a remaining associated with the first centralized SMD (that is, centralized SMD 140). For example, and as discussed above, when moving from a range of the first NCB (that is, NCB1) to a range of the second NCB (that is, NCB2) of the same centralized SMD (that is, RAM centralized SMD), first STA 160a may remain associated to the same centralized SMD (that is, centralized SMD 140).

First STA 160a may use centralized SMD mechanisms of centralized SMD 140 and may smoothly transition from exchanging data through links of the first NCB (that is, NCB1) to exchanging data through the links of the second NCB (that is, NCB2). The AP MLD reconfiguration, add, or delete links protocol may be used to add and delete links as first STA 160a moves between two NCBs of centralized SMD 140. For example, first STA 160a may establish links with the second NCB (that is, NCB2) and delete links established with the first NCB (that is, NCB1).

After transitioning data exchanges for the station from the links of first AP MLD 110 to through the links of second AP MLD 120 at stage 230, method 200 may terminate at end block 240.

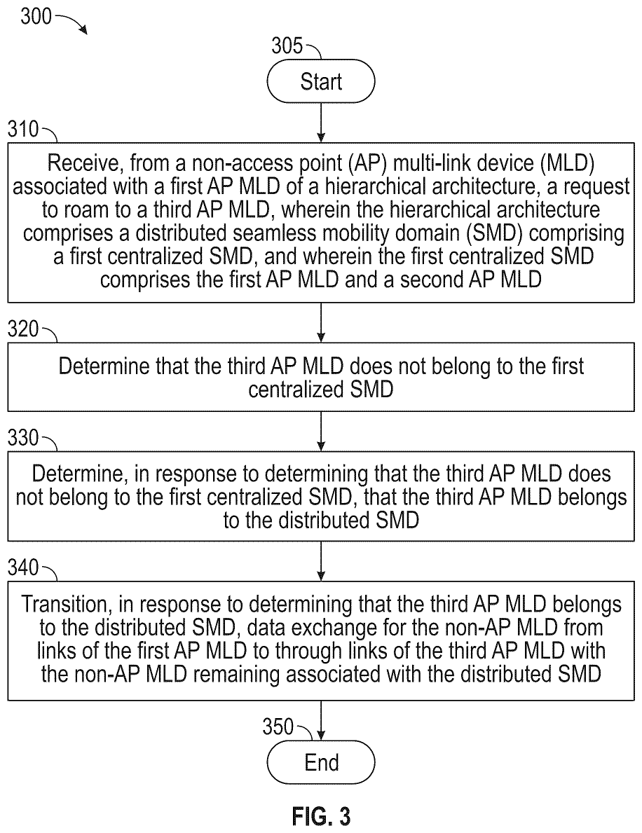

FIG. 3 is a flow chart setting forth the general stages involved in a second method 300 consistent with implementations of the disclosure for enabling roaming in a hierarchical architecture having distributed SMD 145 of centralized SMD 140. Second method 300 may be implemented using first AP MLD 120 or distributed SMD 145 as described in more detail above with respect to FIG. 1. In some examples, second method 300 may be implemented using any of the plurality of AP MLDs as described in more detail above with respect to FIG. 1. Ways to implement the stages of second method 300 will be described in greater detail below.

Method 300 may begin at starting block 305 and proceed to stage 310 first AP MLD 110 may receive a request from non-AP MLD 160 associated with first AP MLD 110 to roam to third AP MLD 130 of a hierarchical architecture. As discussed above, the hierarchical architecture may comprise distributed SMD 145 that may include a first centralized SMD (for example, centralized SMD 140). The first centralized SMD (that is, centralized SMD 140) may comprise first AP MLD 110 and second AP MLD 120. In some examples, the request to roam may be received at third AP MLD 130 if non-AP MLD 160 may have already moved in a range of third AP MLD 130. In some other examples, the request to roam may be received from first STA 160a of non-AP MLD 160.

After receiving the request to roam to third AP MLD 130 from non-AP MLD 160 at stage 310, method 300 may proceed to stage 320 where it may be determined that third AP MLD 130 does not belong to the first centralized SMD (that is, centralized SMD 140). For example, the request to roam may be processed by centralized SMD 140. Centralized SMD 140 may determine that third AP MLD 130 is not its member AP. Centralized SMD 140 then may forward the request to roam to distributed SMD 145.

Once having determined that third AP MLD 130 does not belong to the first centralized SMD at stage 320, method 300 may proceed to stage 330 where it may be determined that third AP MLD 130 belongs to distributed SMD 145. For example, SMD 145 may receive the request to roam from centralized SMD 140 and may determine that third AP MLD 130 belongs to distributed SMD 145. In some examples, distributed SMD 145 may determine that third AP MLD 130 belongs to a second centralized SMD of SMD 145.

Once having determined that third AP MLD 130 belongs to distributed SMD 145 at stage 330, method 300 may proceed to stage 340 where data exchange for non-AP MLD 160 may be transitioned from links of first AP MLD 110 to through links of third AP MLD 130 with non-AP MLD 160 remaining associated with distributed SMD 145. For example, and as discussed above, for first STA 160a moving from a range of the first NCB (that is, NCB1) of centralized SMD 140 to a range of a NCB of a different (that is, a second) centralized SMD in SMD 145, first STA 160a may remain connected with distributed SMD 145. First STA 160a may use the distributed SMD mechanisms and transition from exchanging data through the links of the first NCB (that is, NCB1) of centralized SMD 140 to exchanging data through the links of the NCBs of the second centralized SMD. The distributed SMD mechanisms may involve a roaming preparation phase and then a roaming execution phase, with an uplink pause and a dual downlink phase.

After transitioning data exchanges for non-AP MLD 160 from the links of first AP MLD 110 to through the links of third AP MLD 130 at stage 340, method 300 may terminate at end block 350.

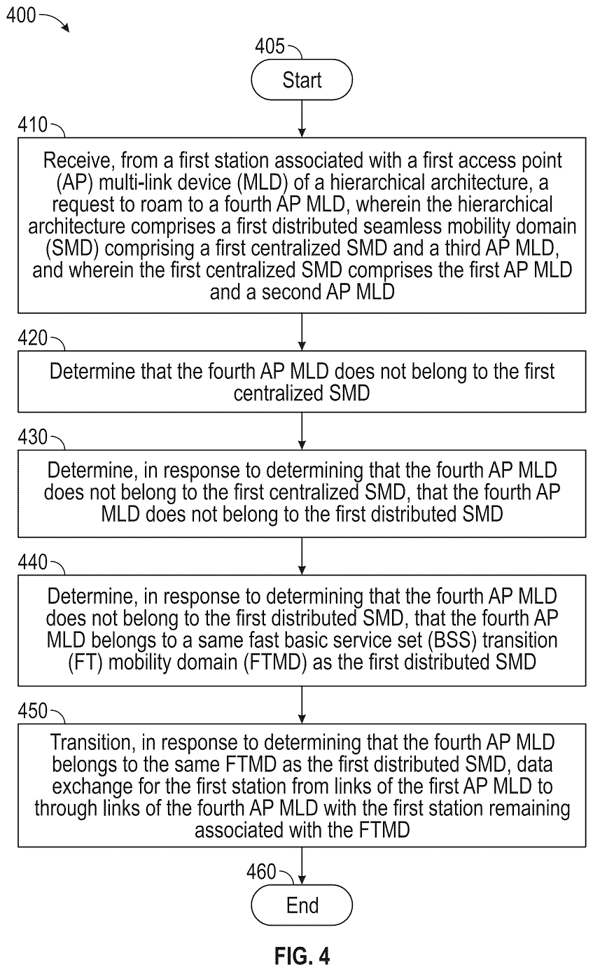

FIG. 4 is a flow chart setting forth the general stages involved in a third method 400 consistent with implementations of the disclosure for enabling roaming in a hierarchical architecture having distributed SMD 145 of centralized SMD 140. Third method 400 may be implemented using first AP MLD 110 and distributed SMD 145 as described in more detail above with respect to FIG. 1. In some examples, method 400 may be implemented using any of the plurality of AP MLDs as described in more detail above with respect to FIG. 1. Ways to implement the stages of third method 400 will be described in greater detail below.

Method 400 may begin at starting block 405 and proceed to stage 410 where first AP MLD 110 may receive a request to roam to a fourth AP MLD from first STA 160a associated with first AP MLD 110 of a hierarchical architecture. As discussed above, the hierarchical architecture may comprise a first distributed SMD (for example, distributed SMD 145) that may include a first centralized SMD (for example, centralized SMD 140) and third AP MLD 130. The first centralized SMD (that is, centralized SMD 140) may comprise first AP MLD 110 and second AP MLD 120. In some examples, the request to roam may be received at the fourth AP MLD if first STA 160a may already have moved in a range of the fourth AP MLD 120.

After receiving the request to roam to the fourth AP MLD at stage 410, method 400 may proceed to stage 420 where it may be determined that the fourth AP MLD does not belong to the first centralized SMD (that is, centralized SMD 140). For example, the request to roam may be processed by centralized SMD 140 that may determine that the fourth AP MLD is not a member AP of centralized SMD 140. Centralized SMD 140 then may forward the request to roam to distributed SMD 145.

Once having determined that the fourth AP does not belong the first centralized SMD at stage 420, method 400 may proceed to stage 430 where it may be determined that the fourth AP does not belong to the first distributed SMD (that is, distributed SMD 145). For example, distributed SMD 145 may receive the roam request from centralized SMD 140 may determine that the fourth AP MLD is not a member AP MLD of distributed SMD 145. Distributed SMD 145 may have information about its member AP MLDs. Distributed SMD 145 then may forward the request to roam to a FTMD.

Once having determined that the fourth AP MLD does not belong to the first distributed SMD at stage 430, method 400 proceed to stage 440 where it be determined that the fourth AP MLD belongs to a same FTMD as the first distributed SMD (that is, distributed SMD 145). For example, the fourth AP MLD may be a part of a second distributed SMD that is a part of the FTMD containing the first distributed SMD (that is, distributed SMD 145).

After determining that the fourth AP MLD belongs to the same FTMD as the first distributed SMD at stage 440, method 400 proceed to stage 450 where data exchanges for first STA 160a may be transitioned from links of first AP MLD 110 to through links of the fourth AP MLD with first STA 160a remaining associated with the FTMD. For example, and as discussed above, for first STA 160a moving from a range of the first NCB (that is, NCB1) of centralized SMD 140 in SMD 145 to a range of a second NCB of a second centralized SMD in a different (that is, a second) distributed SMD of the FTMD, first STA 160a may remain part of the same FTMD. First STA 160a may use the FTMD mechanisms and transition from exchanging data through the links of the first NCB (that is, NCB1) of centralized SMD 140 of distributed SMD 145 to exchanging data through links of the second NCB of the second centralized SMD of the second distributed SMD. The FTMD mechanisms may involve a FT request and response frames.

After transitioning data exchanges for non-AP MLD 160 from the links of first AP MLD 110 to through the links of the fourth AP MLD at stage 450, method 400 may terminate at end block 460.

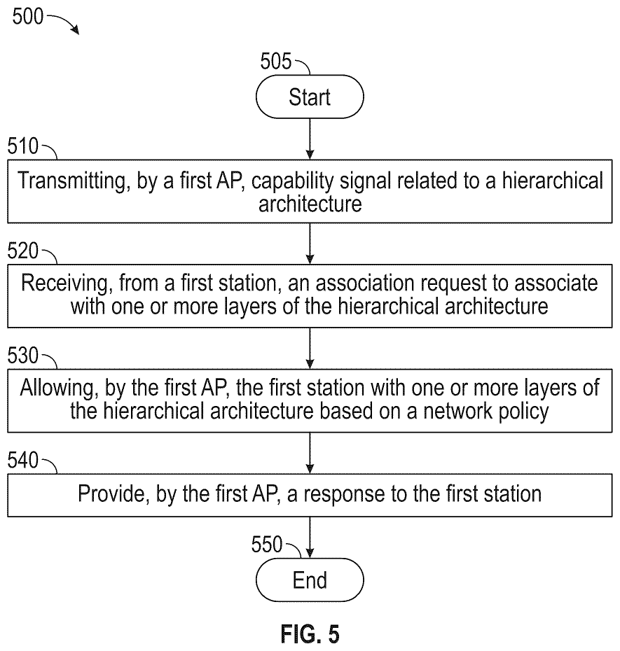

FIG. 5 is a flow chart setting forth the general stages involved in a method 500 consistent with implementations of the disclosure for associating with a hierarchical architecture. Method 500 may be implemented using first AP 110a or controller 105 as described in more detail above with respect to FIG. 1. In some examples, method 500 may be implemented using any of the plurality of APs as described in more detail above with respect to FIG. 1. Ways to implement the stages of method 500 will be described in greater detail below.

Method 500 may begin at starting block 505 and proceed to stage 510 where first AP 110a may transmit a capability signal related to a hierarchical structure. For example, first AP 110 may transmit the capability signal related to different tiers of the hierarchical architecture, that is, for each of the FTMD, distributed SMD 145, the EFT, and centralized SMD 140. The capability signal may be transmitted in one or more of a beacon, a probe response, association response, and a reassociation response. The capability signal may be provided either via two or more separate elements for each tier or via one element with two or more different sub-elements for each tier. In some other examples, the capability signal may be provided in one element with two or more fields, each field being indicative of a tier.

In some examples, non-AP STA 160 may also transmit a capability signal related to different tiers of the hierarchical architecture, that is, for each of the FTMD, distributed SMD 145, the EFT, and centralized SMD 140. In one example, non-AP STA 160 may also transmit the capability signal in one or more of a probe request, an association request, and a re-association request. The capability signal may be provided either via two or more separate elements for each tier or via one element with two or more different sub-elements for each tier. In some other examples, the capability signal may be provided in one element with two or more fields, each field being indicative of a tier.

After transmitting the capability signal related to the hierarchical structure at stage 510, method 500 may proceed to stage 520 where first AP 110a may receive an association request from first STA 160a to associate with two or more tiers of the hierarchical architecture.

Once having received the association request from first STA 160a to associate with the two or more tiers of the hierarchical architecture at stage 520, method 500 may proceed to stage 530 where first AP 110a may allow first STA 160a to associate with one or more tiers of the hierarchical architecture based on a network policy.

After allowing first STA 160a to associated with the one or more tiers of the hierarchical architecture based on the network policy having at stage 530, method 500 proceed to stage 540 where first AP 110a may provide a response to first STA 160a. The response may have individualized responses (accept/reject/come back with a different request) for each tier of the hierarchy or a single response for all requested tiers. After providing the response to first STA 160a at stage 540, method 500 may terminate at end block 550.

In some example embodiments, the processes disclosed herein may perform simultaneous teardown for two or more tiers of the roaming hierarchy. For example, first STA 160a or first AP 110a may indicate teardown of membership of from each of the FTMD, distributed SMD 145, the EFT, and centralized SMD 140 agreements via a teardown request or a disassociation request.

To achieve smooth roaming with minimal pause while preserving scalable backhaul network requirements, processes disclosed herein may provide a hierarchical roaming method whereby connectivity within centralized SMD 140 is used first where possible, else then improved roaming between centralized SMDs of distributed SMD 145 and a FTMD may be performed, else then improved roaming between centralized SMD 140 and an AP MLD is performed, else then an improved roaming between AP MLDs of distributed SMD 145 and the FTMD is performed, and else then legacy FT roaming is performed within the AP MLDs of an FTMD may be performed.

FIG. 6 shows computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for enabling roaming in a hierarchical architecture having a distributed SMD 145 with centralized SMD 140 as described above with respect to FIGS. 2-5. Computing device 600, for example, may provide an operating environment for controller 105, first AP MLD 110, second AP MLD 120, third AP MLD 130, centralized SMD 140, distributed SMD 145, DS 150, and non-AP MLD 160. Controller 105, first AP MLD 110, second AP MLD 120, third AP MLD 130, centralized SMD 140, distributed SMD 145, DS 150, and non-AP MLD 160 may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 600 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
receiving, from a first station associated with a first access Point (AP) Multi-Link Device (MLD) of a hierarchical architecture, a request to roam to a second AP MLD, wherein the hierarchical architecture comprises a distributed Seamless Mobility Domain (SMD) comprising a first centralized SMD, and wherein the first centralized SMD comprises the first AP MLD;
determining that the second AP MLD belongs to the first centralized SMD; and
transitioning, in response to determining that the second AP MLD belongs to the first centralized SMD, data exchanges for the first station from links of the first AP MLD to through links of the second AP MLD with the first station remaining associated with the first centralized SMD.

2. The method of claim 1, wherein transitioning the data exchanges for the first station from the links of the first AP MLD to through the links of the second AP MLD comprises:
forming the links with the second MLD.

3. The method of claim 1, further comprising:
forming the links of the first AP MLD and the links of the second AP MLD during an association.

4. The method of claim 1, wherein the distributed SMD comprises the centralized SMD and a third AP MLD.

5. The method of claim 1, wherein the first centralized SMD is a logical entity hosted on a centralized box on one or more member AP MLDs of the first centralized SMD.

6. The method of claim 1, wherein the first centralized SMD is a logical entity hosted on a centralized box on a Wireless Local Area Network (LAN) Controller (WLC).

7. The method of claim 1, further comprising:
tearing down association of the first station with one or more tiers of the hierarchical architecture.

8. A system comprising:
a memory storage; and
a processing unit coupled to the memory storage, wherein the processing unit is operative to:
receive, from a non-Access Point (AP) Multi-Link Device (MLD) associated with a first AP MLD of a hierarchical architecture, a request to roam to a third AP MLD, wherein the hierarchical architecture comprises a distributed Seamless Mobility Domain (SMD) comprising a first centralized SMD, and wherein the first centralized SMD comprises the first AP MLD and a second AP MLD;
determine that the third AP MLD does not belong to the first centralized SMD;
determine, in response to determining that the third AP does not belong to the first centralized SMD, that the third AP MLD belongs to the distributed SMD; and
transition, in response to determining that the third AP MLD belongs to the distributed SMD, data exchanges for the non-AP MLD from the first AP MLD to through links of the third AP MLD with the non-AP MLD remaining associated with the distributed SMD.

9. The system of claim 8, wherein the processing unit is operative to determine that the third AP MLD does not belong to the first centralized SMD comprises the processing unit is operative to:
determine that the third AP MLD belongs to a second centralized SMD of the distributed SMD.

10. The system of claim 9, wherein the processing unit is further operative to:
perform a context transfer for the non-AP MLD from the first centralized SMD to the second centralized SMD.

11. The system of claim 8, wherein the distributed SMD is a logical entity and resides on a Wireless Local Area Network (LAN) Controller (WLC).

12. The system of claim 8, wherein the distributed SMD is a logical entity distributed across the first centralized SMD and the third AP MLD.

13. The system of claim 8, wherein the first centralized SMD is a logical entity hosted on a centralized box on one or more member AP MLDs of the first centralized SMD or on a Wireless Local Area Network (LAN) Controller (WLC).

14. The system of claim 8, further comprising:
tearing down association of the non-AP MLD with one or more tiers of the hierarchical architecture.

15. A non-transitory computer-readable medium that stores a set of instructions which when executed perform a method executed by the set of instructions comprising:
receiving from a first station associated with a first access Point (AP) Multi-Link Device (MLD) of a hierarchical architecture, a request to roam to a fourth AP MLD, wherein the hierarchical architecture comprises a first distributed Seamless Mobility Domain (SMD) comprising a first centralized SMD and a third AP MLD, and wherein the first centralized SMD comprises the first AP MLD and a second AP MLD;
determining that the fourth AP MLD does not belong to the first centralized SMD;
determining, in response to determining that the fourth AP MLD does not belong to the first centralized SMD, that the fourth AP does not belong to the first distributed SMD;
determining, in response to determining that the fourth AP MLD does not belong to the first distributed SMD, that the fourth AP MLD belongs to a same Fast Basic Service Set (BSS) Transition (FT) Mobility Domain (FTMD) as the first distributed SMD; and
transitioning, in response to determining that the fourth AP MLD belongs to the same FTMD as the first distributed SMD, data exchanges for the first station from links of the first AP MLD to through links of the fourth AP MLD with the first station remaining associated with the FTMD.

16. The non-transitory computer readable medium of claim 15, wherein the distributed SMD is a logical entity and resides on a Wireless Local Area Network (LAN) Controller (WLC).

17. The non-transitory computer-readable medium of claim 16, wherein the distributed SMD is a logical entity distributed across the first centralized SMD and the third AP MLD.

18. The non-transitory computer-readable medium of claim 17, wherein the first centralized SMD is a logical entity hosted on a centralized box, on one or more member AP MLDs of the first centralized SMD, or on a Wireless Local Area Network (LAN) Controller (WLC).

19. The non-transitory computer-readable medium of claim 18, wherein transitioning the data exchange for the first station from the links of the first AP MLD to through the links of the fourth AP MLD comprises re-associating with the fourth AP MLD.

20. The non-transitory computer readable medium of claim 15, further comprising:
tearing down association of the first station with one or more tiers of the hierarchical architecture.
